(19) United States
(12) Patent Application Publication
(10) Pub. No.: US 2019/0087862 A1
(43) Pub. Date: Mar. 21, 2019

(54) DETECTION OF ABANDONED ITEM WITHIN A VENUE

(71) Applicant: SYMBOL TECHNOLOGIES, LLC, Lincolnshire, IL (US)

(72) Inventors: Andrew Schiano, West Islip, NY (US); Ian L. Fade, Nesconset, NY (US); Eric McCafferty, Manorville, NY (US)

(21) Appl. No.: 15/706,248

(22) Filed: Sep. 15, 2017

(51) Int. Cl. G06Q 30/02

(52) U.S. Cl. CPC G06Q 30/0261; H04W 4/02; G06Q 30/0267; G06Q 30/0255

(57) ABSTRACT

A method and apparatus for detecting an abandoned item within a venue. Individuals may express interest in a physical item displayed within a venue such as an item offered for sale at a retail sales venue. The person may indicate interest in the item by physically handling the item, looking at the item for a period of time, or placing the item in a shopping cart. If the individual leaves the item at a different area of the retail sales venue and does not complete a transaction with respect to the item, then the item is considered to have been abandoned by the individual. The abandonment is detected according to an array of sensor disposed proximate to the venue. A second-chance offer is communicated to the individual for the abandoned item.

### BACKGROUND OF THE INVENTION

People visiting a venue (e.g., a retail sales floor) sometimes express interest in an item (e.g., a product for sale) but do not complete a transaction with respect to the item. Instead of completing a transaction with respect to the item, the person may choose to abandon the item in the venue.

Accordingly, there is a need for detection of an abandoned item within a venue because there is an increased likelihood that the person will choose to complete a transaction with respect to the abandoned item at a future time.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for detecting an abandoned item within a venue in accordance with some embodiments.

FIG. 2 is an example notification of a second chance offer on an item abandoned within a venue to the person who abandoned the item in accordance with some embodiments.

FIG. 3 is another example notification of a second chance offer on an item abandoned within a venue to the person who abandoned the item in accordance with some embodiments.

FIG. 4 is another example notification of a second chance offer on an item abandoned within a venue to the person who abandoned the item in accordance with some embodiments.

FIG. 5 is a block diagram of a system for detecting an abandoned item within a venue with an abandoned item server in accordance with some embodiments

FIG. 6 is a flowchart of a method of detecting abandoned merchandise within a venue having a network of transceivers in accordance with some embodiments.

FIG. 7 is a flowchart of a method determining a second-chance offer for an abandoned item in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In some implementations, a method of detecting abandoned merchandise within a venue having a network of transceivers includes determining a customer identity of a person at a venue, periodically monitoring, by the network of transceivers, a location of the person at the venue, periodically monitoring, by the network of transceivers, a location of a physical item offered for sale at the venue having an offered sales price. The method further includes associating the physical item with the customer identity based on an interaction between the person and the physical item, detecting an adjustment to the offered sales price of the physical item, and communicating the adjustment to the offered sales price of the physical item to the person.

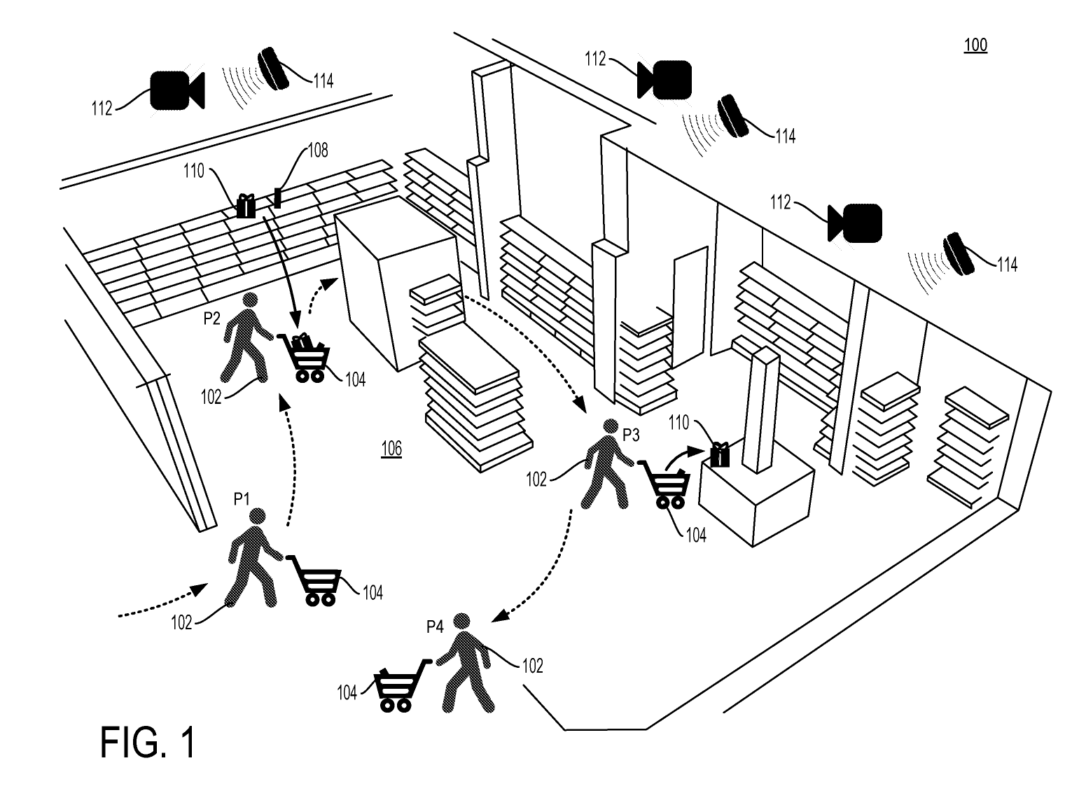

FIG. 1 is a diagram of a system 100 for detecting an abandoned item within a venue 106 in accordance with some embodiments. The venue 106 may be an area, whether enclosed or not with items displayed to a person 102 (e.g., a retail sales floor, a concert venue, an exposition display space, a sporting arena, etc.). In the example illustrated in FIG. 1, the venue 106 is a store that stocks products for sale in display areas located at various places around the venue 106.

Disposed above the venue 106 is an array of sensors configured to recognize physical items in the venue and to detect when physical items have moved within the venue. In some implementations, the sensors include radio-frequency identification (RFID) antennas 114 disposed above the venue 106 and physical items displayed within the venue include RFID tags. The RFID tags may uniquely identify physical items displayed within the venue 106 or the RFID tags may generically identify physical items (e.g., according to SKU number). In some implementations, the sensors are not disposed above the venue 106, but may be disposed in other areas proximate to the venue (e.g., in the venue floor, walls, outside the venue but within transmission range, etc.).

The sensors disposed above the venue 106 may alternatively or additionally include video cameras 112. The video cameras 112 may record a video feed including at least a portion of the physical items displayed within the venue 106. The video cameras 112 or an imaging device attached thereto may recognize the physical items displayed within the venue 106 based on physical characteristics of the physical items. The video cameras 112 may detect only that a person has moved a physical item from one part of the venue 106 to another part of the venue 106, and the RFID antennas 114 may complete the identification of the moved physical item.

In the example illustrated in FIG. 1, a person 102 enters the venue 106 at a location P1. In some implementations, the person is accompanied by a shopping cart 104 into which the person 102 may place physical items. At a location P2, the person 102 has moved to a portion of the venue 106 where physical items 108 and 110 are displayed. The person 102 places the physical items 108 and 110 in the shopping cart 104. Alternatively, the person 102 may carry the physical items 108 and 110, carry the physical items 108 and 110 in a bag, or otherwise take physical possession of the items. In some implementations, the person 102 need not take physical possession of the physical items 108 and 110, but can instead express an interest in one or more of the physical items 108 and 110 (e.g., looking at the physical item for a period of time, reading text on the physical item, remaining stationary near the physical item for a period of time, etc.).

At a location P3, the person 102 has removed physical item 110 from the shopping cart 104 and placed the item on a retail sales display within the venue 106. At a location P4, the person 102 exits the venue 106, for example to enter a checkout area where physical item 104 is purchased by the person 102.

When the person 102 places the physical item 110 on the display area within the venue 106 at location P3, the physical items 110 can be said to have been abandoned within the venue 106. Abandonment of the physical item 110 is detected by one or more of the sensors 112 and 114 arrayed proximate to the venue 106. In some implementations, the RFID antennas 114 trilaterate the position of the physical item 110 within the venue 106 according to relative signal strength of an RFID signal received by various of the RFID antennas 114 positioned at different locations from one another with respect to the venue 106. In other implementations, the video cameras 112 recognize the physical item 110 and a location of the physical item within the venue 106 after the physical item 110 has been abandoned. Combinations of detection of the video cameras 112 and the RFID antennas 114 may also be used to detect abandonment location of the physical item 110 (e.g., the video cameras 112 detect abandonment of an item and the RFID antennas 114 detect the identity of the item that has been abandoned).

In at least one implementation, abandonment of the physical item 110 is detected by a co-pathular movement of the person 102 and the physical item 110 followed by a divergence of the positions of the person 102 and physical item 110. The divergence of the positions of the person 102 and the physical item 110 may include the person 102 moving while the physical item 110 remains stationary (abandoned item on a display area) or may include both the person 102 and the physical item 110 moving in a non-co-pathular manner (e.g., the person 102 hands the abandoned item to a staffer of the venue 106.

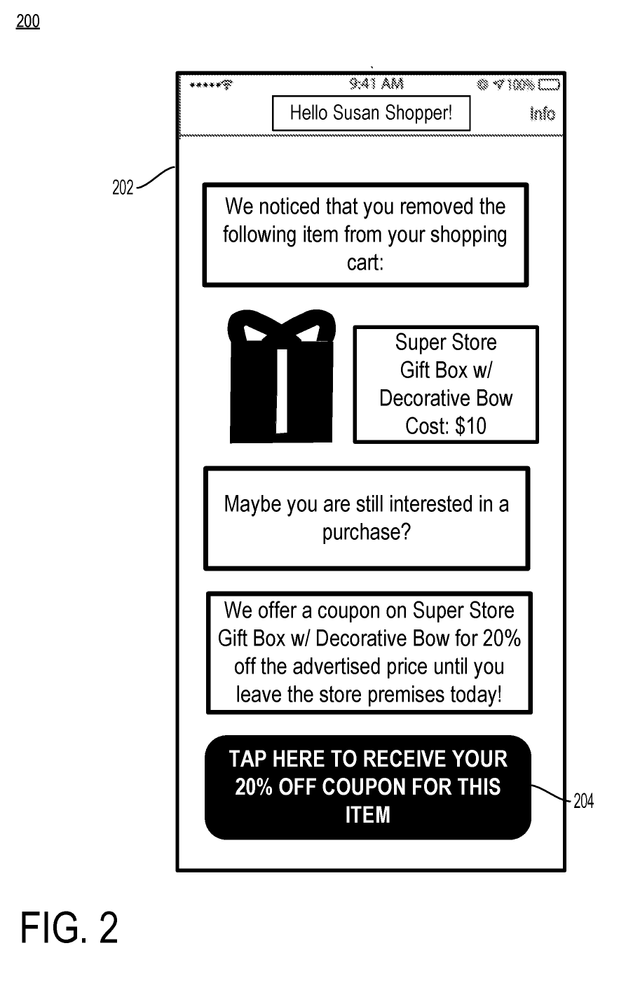

FIG. 2 is an example notification 200 of a second-chance offer on an item abandoned within a venue to the person who abandoned the item in accordance with some embodiments. The notification 200 may be displayed on a mobile device screen 202 to the person who has abandoned the item. The person to whom the notification 200 is sent may be identified in several ways. In some implementations, the person is identified according to a mobile device associated with the person. A mobile device associated with the person may include an application executing on the mobile device associated with the venue. The application executing on the mobile device may determine that the device is within the venue based on locationing services of the mobile device (e.g., recognition of, or connection to, a wireless network known to be available at the venue based on SSID, GPS services on the mobile device, interaction with the person indicating presence at the venue, etc.). Once the mobile device has determined that it is physically located within the venue, the application executing on the mobile device may communicate an identity of the person associated with the mobile device to components of the system for detecting abandoned physical items within the venue (e.g., wireless communication of the identity). In some implementations, the mobile device associated with the person may determine and transmit the person's location within the venue to components of the system for detecting abandoned physical items within the venue (e.g., ultrasonic locationing, locationing based on a wireless beacon, locationing based on relative wireless signal strengths, via the camera or other sensors of the mobile device, etc.).

Another way to identify the person to whom the notification 200 should be sent is via RFID identification of the person. For example, without limitation, the person may carry a card associated with the venue (e.g., a frequent shopper card, a museum membership card, etc.) including an RFID tag that can be detected by the array of RFID antennas disposed proximate to the venue. Once the RFID tag associated with the person has been detected by the array of RFID antennas, an identity of the person may be associated with any abandoned items. In other implementations, the array of cameras may recognize the person (e.g., via facial recognition). Combinations of these implementations may also be employed. For example, a person may be recognized upon entry to a venue based on an RFID tag detection or via a mobile device. Once it is known that a particular person is within a venue, the person may be tracked according to other method such as via video recognition. In some implementations, characteristics that are known to be associated with a person (age, gender, height, facial appearance, etc.) may be used by the array of video cameras to track the person within a venue. For example, if it is known from mobile device and RFID scanning that only one woman is present in a venue among a group of several shoppers, then a video camera may be able to identify the person based on physical appearance associated with the person's gender.

The notification 200 may include various pieces of information displayed on the mobile device screen 202. The notification 200 may take other forms of communication to the person such as instant message, social media message, email, pop in an application executing on the mobile device associated with the venue, voice call, etc. In at least one implementation, the notification 200 is sent to the person while she is still within the venue, such as before the person enters a checkout area where physical items may be purchased. The notification 200 may include an identification of the abandoned physical item and an offer to purchase the item. In some implementations, the notification 200 includes a discount to a regular sales price of the physical item (e.g., a 20% discount to the regular sales price). The notification 200 may include a button 204 to initiate a request to purchase the physical item at the discounted sales price. In some implementations, the button 204 causes the display of a coupon for presentation at a checkout area for purchase of the physical item.

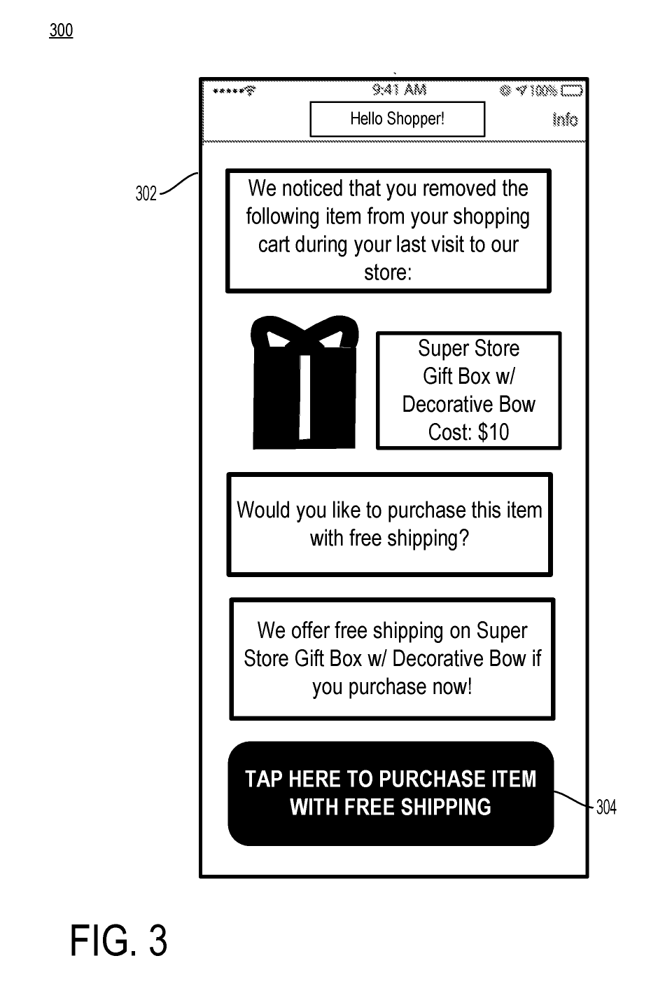

FIG. 3 is another example notification 300 of a second-chance offer on an item abandoned within a venue to the person who abandoned the item in accordance with some embodiments. The notification 300 may include various pieces of information displayed on the mobile device screen 302. The notification 300 may take other forms of communication to the person such as instant message, email, social media message, pop-up in an application executing on the mobile device associated with the venue, voice call, etc. In at least one implementation, the notification 300 is sent to the person after she has left the venue, such as after a period of time has elapsed after the person left the physical confines of the venue. The notification 300 may include an identification of the abandoned physical item and an offer to purchase the item. In some implementations, the notification 300 includes an offer for free shipping of the physical item. The notification 300 may include a button 304 to initiate a request to purchase the physical item with free shipping. In some implementations, tapping the button 304 initiates a purchase of the item with free shipping, such as through an online checkout process.

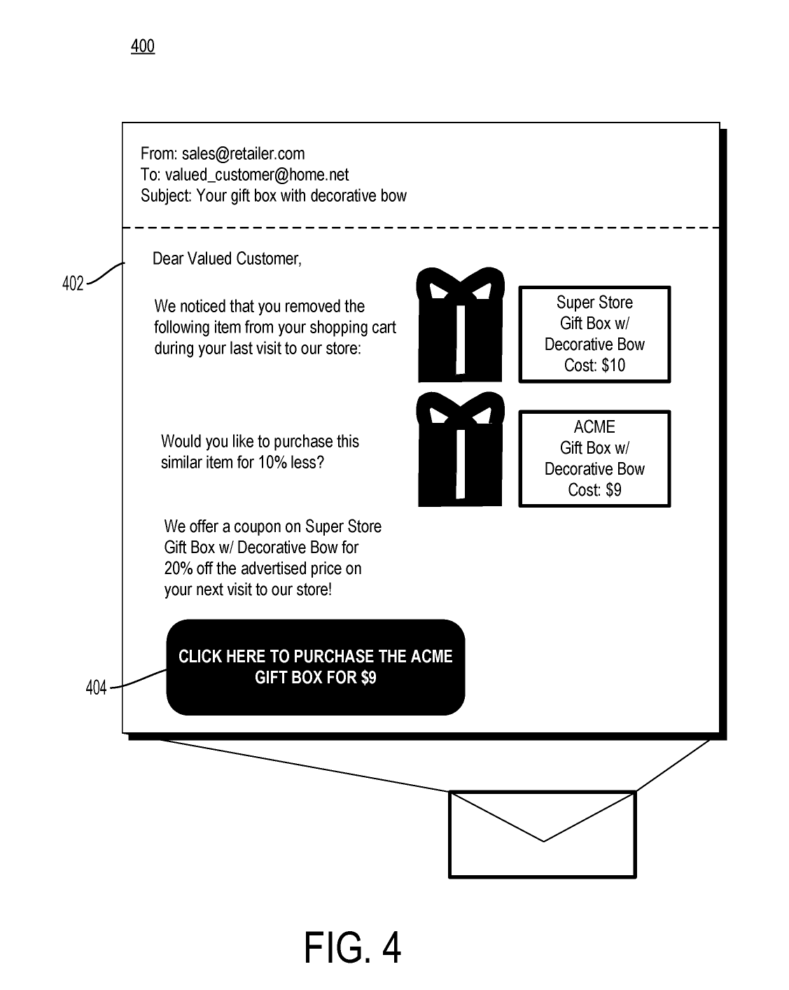

FIG. 4 is another example notification 400 of a second-chance offer on an item abandoned within a venue to the person who abandoned the item in accordance with some embodiments. The notification 400 may include various pieces of information displayed in a message to the person, such as in an email 402. The notification may take other forms of communication to the person such as instant message, social media message, pop-up in an application executing on the mobile device associated with the venue, voice call, etc. In at least one implementation, the notification 400 is sent to the person after she has left the venue, such as after a period of time has elapsed after the person left the physical confines of the venue. The notification 400 may include an identification of the abandoned physical item and an offer to purchase a substitute item. The substitute item may be an item that has similarities with the abandoned item, but that is different in other ways, such as offered price. The notification 400 may include a link 404 to initiate a request to purchase the substitute physical item. In some implementations, clicking the link 404 initiates a purchase of the substitute item, such as through an online checkout process.

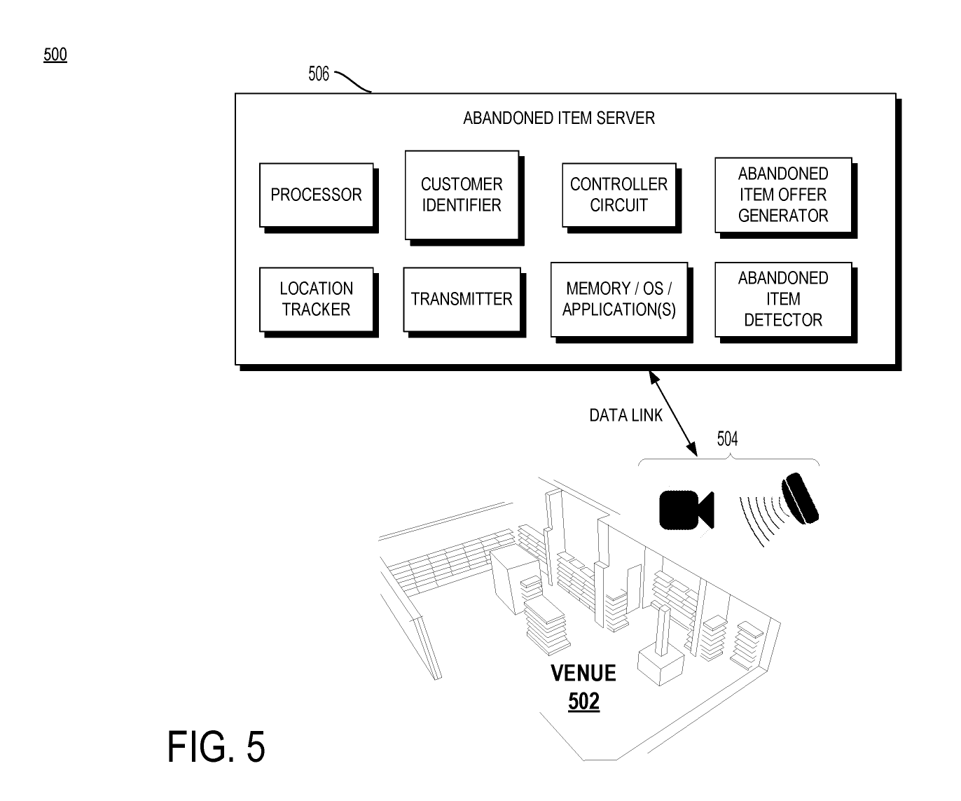

FIG. 5 is a block diagram of a system 500 for detecting an abandoned item within a retail venue 502 with an abandoned item server in accordance with some embodiments. The retail venue 502 may include any physical area wherein items are displayed to people within the area. Disposed proximate to the area are one or more locationing sensors 504. The locationing sensors 504 may include video cameras, RFID antennas, pressure sensors, motion sensors, or any other type of sensor for determining the presence and movement of people and physical items.

The locationing sensors 504 are communicatively coupled to an abandoned item server 506. The abandoned item server 506 includes components for detecting a physical item abandoned by a person within the retail venue 502 and communicating a second-chance offer to the person regarding the abandoned item. Components of the abandoned item server 506 include a processor and memory/OS/application(s) configured to perform any of the functions described herein. The abandoned item server 506 further includes a customer identifier for determining a customer identity of a person on the retail sales floor. The customer identifier may identify a customer on the retail venue 502 by interactions with the locationing sensors 504 (e.g., facial recognition, RFID tag recognition, etc.) or through recognition of a mobile device associated with the person (e.g., an application executing on the mobile device, etc.).

A location tracker of the abandoned item server 506 tracks the location of the person within the retail sales venue 502 and tracks the location of physical items displayed on the retail sales venue 502. The location tracker may rely on the locationing sensors 504 and/or other sensors (weight sensor, motion sensor, etc.) to track the location of physical items and persons. In some implementations, the location tracker periodically determines a location of the person on the retail venue 502 and periodically determines a location of physical items offered for sale on the retail venue 502, such as by a polling signal to receive location information at regular intervals.

The abandoned item detector determines that a physical item is abandoned by the person on the retail venue 502. The abandoned item detector may base a determination that an item has been abandoned by the person if the physical item was temporarily in possession of the person on the retail sales venue. In other implementations, the abandoned item offer generator may base a determination that an item has been abandoned by the person if the physical item moved from a first location on the retail venue 502 to a second location on the retail venue 502. In other implementations, the abandoned item offer generator may base a determination that an item has been abandoned if the item and the person pursue a co-pathular route on the retail venue 502 for a first period of time, followed by a second period of time during which the person and the physical item do not follow a co-pathular route on the retail venue 502.

An abandoned item offer generator communicates a sales offer to the person for the physical item if the abandoned item generator determines that the item has been abandoned. The sales offer may include an offer for the abandoned item at a price lesser than an advertised sale price. The sales offer may alternatively include an offer with free shipping for the abandoned item. The sales offer may additionally or alternatively include an offer for a substitute item that shares characteristics with the abandoned item but also includes differences (e.g., different price, higher margin, higher stock count, etc.). The abandoned item offer generator may transmit the sales offer to the person via a transmitter on the abandoned item server 506.

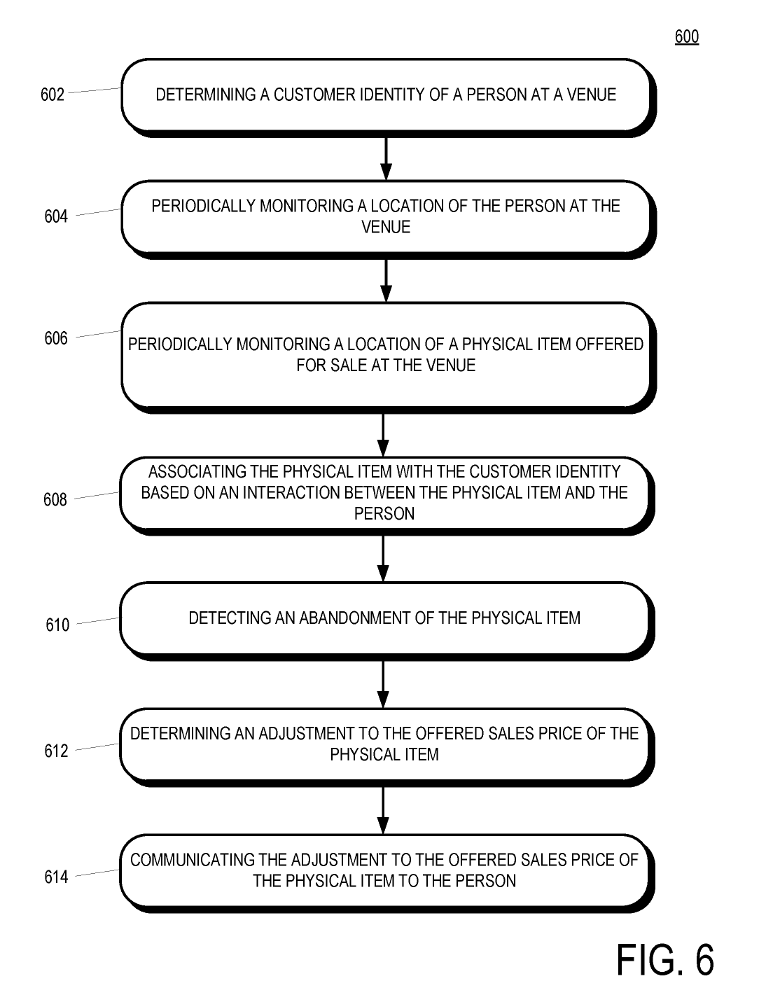

FIG. 6 is a flowchart of a method 600 of detecting abandoned merchandise within a venue having a network of transceivers in accordance with some embodiments. The method 600 includes a determining operation 602 that determines a customer identity of a person at a venue. The determining operation 602 may identify the customer according to recognition of a mobile device associated with the person, according to facial recognition technology, according to a customer self-identification, etc.

A monitoring operation 604 periodically monitors a location of the person at the venue. The monitoring operation 604 may be performed by sensors proximate to the venue such as video cameras, RFID antennas, etc. The monitoring operation 604 may poll the location of the person over a period of time, such as after the person was first detected at the venue until the person is no longer present at the venue. Another monitoring operation 606 periodically monitors a location of a physical item offered for sale at the venue. The monitoring operation 606 may poll the location of the physical item (e.g., RFID tag recognition) over an interval of time.

An associating operation 608 associates the physical item with the customer identity based on an interaction between the physical item and the person. The association between the physical item and the person may include an interaction between the person and the item (e.g., the person physical pickup up the item, the person reading text on the item, the person carrying the item to a different location within the venue, a co-pathular movement of the person and the item, etc.).

A detecting operation 610 detects an abandonment of the physical item. The detecting operation 610 may be based on a movement of the person and the item that is not co-pathular after a period of time during which the movement of the person and the item is co-pathular. The detecting operation 610 may additionally or alternatively be based on a movement of the person while the item remains stationary in the same or a different portion of the venue that the portion of the venue in which the item was originally displayed.

A determining operation 612 determines an adjustment to the offered sales price of the physical item. The adjustment may be a downward adjustment and may be further based on a period of time after the detecting operation 610 or based on other factors such as item margin or inventory levels of the item. A communicating operation 614 communicates the adjust to the offered sales price of the physical item to the person. The communicating operation 614 may include transmitting the sales offer via a mobile device, an email, an instant message, a social message, etc. The communicating operation 614 may further be based on a period of time after the detecting operation 610 (e.g., a day after the person has left the venue, after an excess inventory condition has been met with respect to the item, etc.).

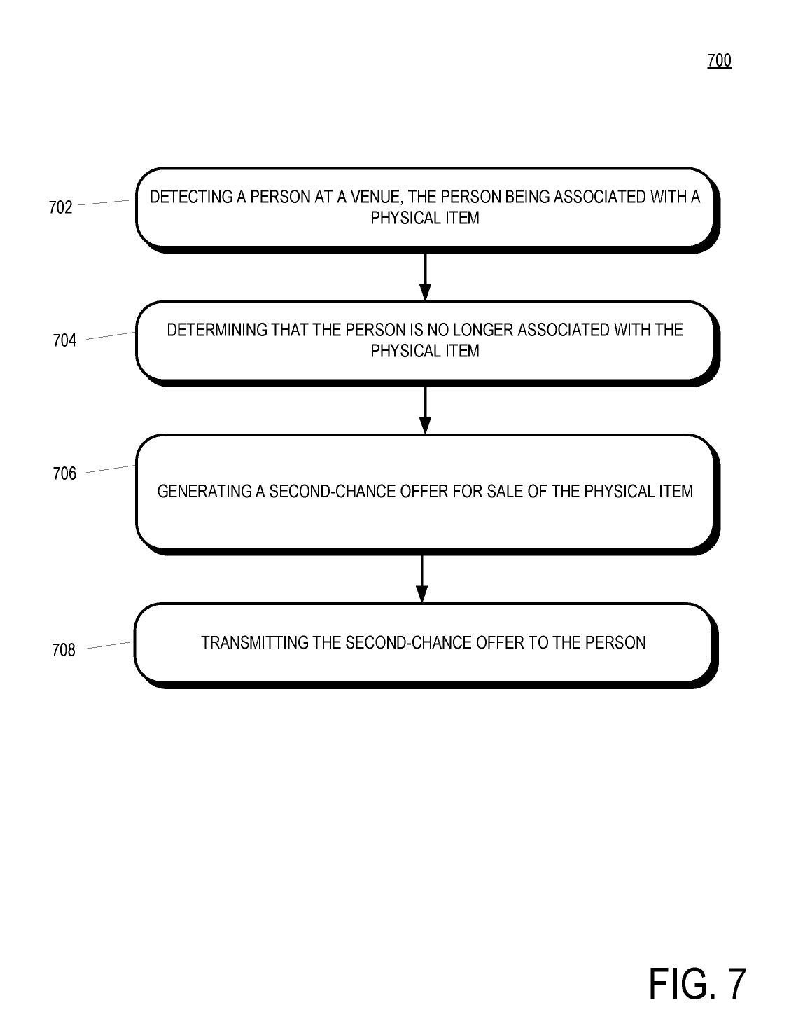

FIG. 7 is a flowchart of a method 700 for determining a second-chance offer for an abandoned item in accordance with some embodiments. The method 700 includes a detecting operation 702 that detects a person at a venue being associated with a physical item. A determining operation 704 determines that the person is no longer associated with the physical item. A generating operation 706 generates a second-chance offer for the sale of the physical item. The second-chance offer may be an adjustment to a price for the physical item, such as a reduction to a previously offered price for the item (e.g., the price at which the item was offered when the customer was at the venue). In other implementations, the sales offer may include an incentive such as free shipping on the item. In yet other implementations, the sales offer may include an offer for a substitute item that shares characteristics with the abandoned item.

A transmitting operation 708 transmits the second-chance offer for the physical item to the person. The transmitting operation 708 may communicate the second-chance offer while the person is still within the venue or after the person has left the venue. The transmitting operation 708 may include transmitting the second-chance offer via a mobile device, an email, an instant message, a social message, etc. The transmitting operation 708 may further be based on a period of time after the determining operation 704 (e.g., a day after the person has left the venue, after an excess inventory condition has been met with respect to the item, etc.).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method of detecting abandoned merchandise within a venue having a network of transceivers, the method comprising:
determining a customer identity of a person at a venue;
periodically monitoring, by the network of transceivers, a location of the person at the venue;
periodically monitoring, by the network of transceivers, a location of a physical item offered for sale at the venue, the physical item having an offered sales price;
associating the physical item with the customer identity based on an interaction between the person and the physical item;
detecting an abandonment of the physical item based on the operations that monitor the location of the physical item and the location of the person;
determining an adjustment to the offered sales price of the physical item; and
communicating the adjustment to the offered sales price of the physical item to the person.

2. The method of claim 1, wherein the interaction between the person and the physical item includes one of the person placing the physical item in a shopping cart and the person carrying the physical item.

3. The method of claim 1, wherein the operation that determines the customer identity includes ultrasonic locationing of a mobile device associated with the customer identity by the network of transceivers.

4. The method of claim 1, wherein the operation that determines the customer identity includes detecting a radio-frequency identification tag associated with the person.

5. The method of claim 1, wherein the operation that monitors the location of the physical item includes radio-frequency identification.

6. The method of claim 1, wherein the operation that detects the abandonment of the physical item is based at least in part on a movement of the person relative to the item.

7. An abandoned merchandise detection system, the system comprising:
one or more locationing sensors, the locationing sensor within a retail venue disposed proximate to a retail sales floor, and the sales floor including at least one physical item offered for sale at a first price;
a customer identifier configured to determine a customer identity of a person within the retail venue;
a location tracker configured to periodically determine a location of the person on the retail venue and to periodically determine a location of the at least one physical item offered for sale on the sales floor;
an abandoned item detector generator configured to determine that the at least one physical item is abandoned by the person based on the periodically determined location of the person on the retail venue and the periodically determined location of the at least one physical item; and
an abandoned item offer generator configured to communicate a sales offer to the person for the physical item at a second price.

8. The system of claim 7, wherein the sales offer is communicated to the person by the abandoned item offer generator before the person leaves the retail venue.

9. The system of claim 7, wherein the sales offer is communicated to the person by the abandoned offer generator after the person has left the retail venue.

10. The system of claim 7, wherein the sales offer is communicated to the person for display on a mobile device.

11. The system of claim 7, wherein the abandoned item detector determines that the at least one physical item has been abandoned by the person based on a determination that the physical item was temporarily in possession of the person on the retail venue.

12. The system of claim 7, wherein the abandoned item detector determines that the at least one physical item has been abandoned by the person based on a determination that the physical item moved from a first location on the retail venue to a second location on the retail venue.

13. A method of determining a second-chance offer for an abandoned item, the method comprising:
detecting a person at a venue, the person being associated with a physical item;
determining that the person is no longer associated with the physical item;
generating a second-chance offer for sale of the physical item; and
transmitting the second-chance offer to the person.

14. The method of claim 13, wherein the detecting operation includes microlocationing an electronic device associated with the person.

15. The method of claim 13, wherein the person is associated with the physical item according to a co-pathular movement of the person and the physical item.

16. The method of claim 13, wherein it is determined that the person is no longer associated with the physical item by detecting that the person moved the physical item to a new location at the venue according to a radio-frequency tag embedded in the physical item.

17. The method of claim 13, wherein the second-chance offer is based at least in part on a length of time that the person was associated with the physical item.

18. The method of claim 13, wherein the second-chance offer is based at least in part on other physical items associated with the person while the person was at the venue.

19. The method of claim 13, wherein the operation that determines that the person is no longer associated with the physical item includes a determination that the person is moving independently from the physical item on the retail sales floor.

20. The method of claim 13, wherein the operation that determines the customer identity includes receiving a notification from an application executing on the mobile device, the notification including a location of the person with respect to the venue.
